(19) United States
(12) Patent Application Publication
(10) Pub. No.: US 2016/0109124 A1
(43) Pub. Date: Apr. 21, 2016

(54) FUEL METERING DEVICE

(71) Applicant: Andrew Crane, Chicopee, MA (US)

(72) Inventor: Andrew Crane, Chicopee, MA (US)

(21) Appl. No.: 14/515,653

(22) Filed: Oct. 16, 2014

(51) Int. Cl. F23N 1/00; F16K 31/06

(52) U.S. Cl. CPC F23N 1/005; F16K 31/0644; F23N 2035/14

(57) ABSTRACT

A fuel metering assembly includes a solenoid fluidly coupled between a fuel supply and a cooking appliance. A timer is electrically coupled to a power source. The timer is additionally electrically coupled to the solenoid such that the timer selectively actuates and de-actuates the solenoid. A plurality of time actuators is coupled to the timer to select a duration of time for the solenoid to be actuated. A display is coupled to the timer. The display displays numerals indicating the selected duration of time. A control is electrically coupled to the timer. A primary actuator is coupled to the control. The primary actuator is engaged by a user such that the timer actuates the solenoid for the selected duration of time. A light emitter is coupled to the control. The light emitter emits light when the primary solenoid is actuated.

### BACKGROUND OF THE DISCLOSURE

### Field of the Disclosure

The disclosure relates to metering devices and more particularly pertains to a new metering device for metering a flow of a fuel to a cooking appliance.

### SUMMARY OF THE DISCLOSURE

An embodiment of the disclosure meets the needs presented above by generally comprising a solenoid fluidly coupled between a fuel supply and a cooking appliance such that the solenoid controls a flow of a fuel to the cooking appliance. A timer is positioned in a secure location such that the timer is concealed from a user. The timer is electrically coupled to a power source. The timer is additionally electrically coupled to the solenoid such that the timer selectively actuates and de-actuates the solenoid. A plurality of time actuators is coupled to the timer. Each of the time actuators is engaged to select a duration of time for the solenoid to be actuated. Thus, the solenoid allows the flow of the fuel to the cooking appliance for the selected duration of time. A display is coupled to the timer. The display displays numerals indicating the selected duration of time. A control is positioned proximate the cooking appliance such that the control is accessible to the user. The control is electrically coupled to the timer. A primary actuator is coupled to the control. The primary actuator is engaged by the user such that the timer actuates the solenoid for the selected duration of time. A light emitter is coupled to the control. The light emitter emits light when the primary solenoid is actuated indicating the solenoid is allowing the flow of the fuel to the cooking appliance. The light emitter ceases emitting light when the timer de-actuates the solenoid.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a fuel metering assembly according to an embodiment of the disclosure.

FIG. 2 is an in-use view of an embodiment of the disclosure.

FIG. 3 is a schematic view of an embodiment of the disclosure.

### DESCRIPTION OF THE PREFERRED EMBODIMENT

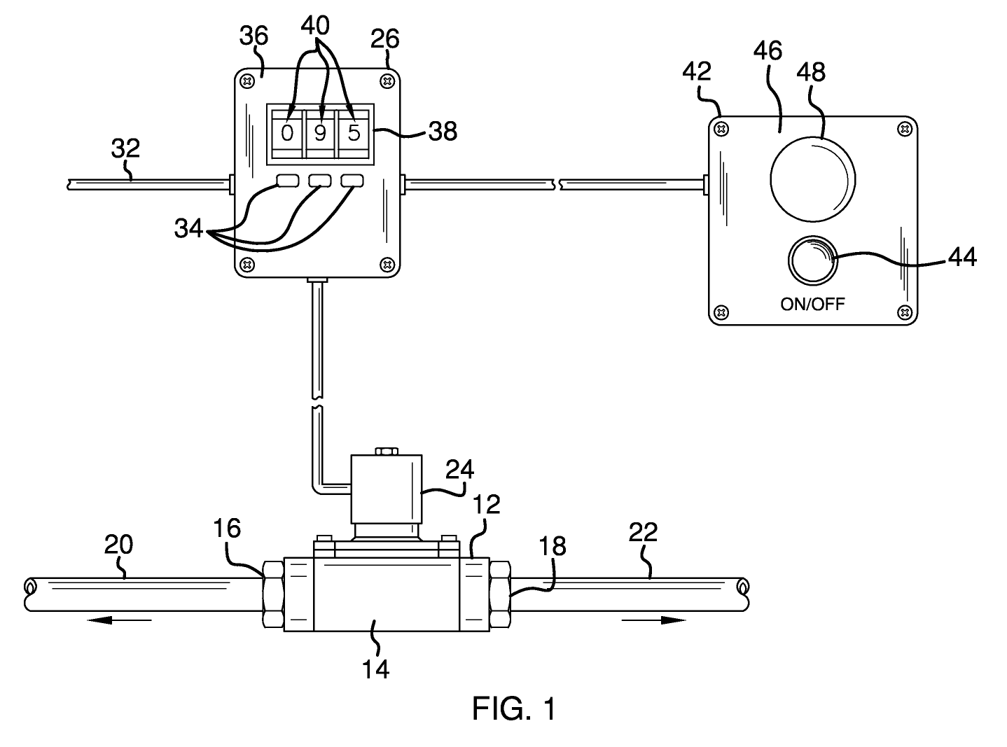

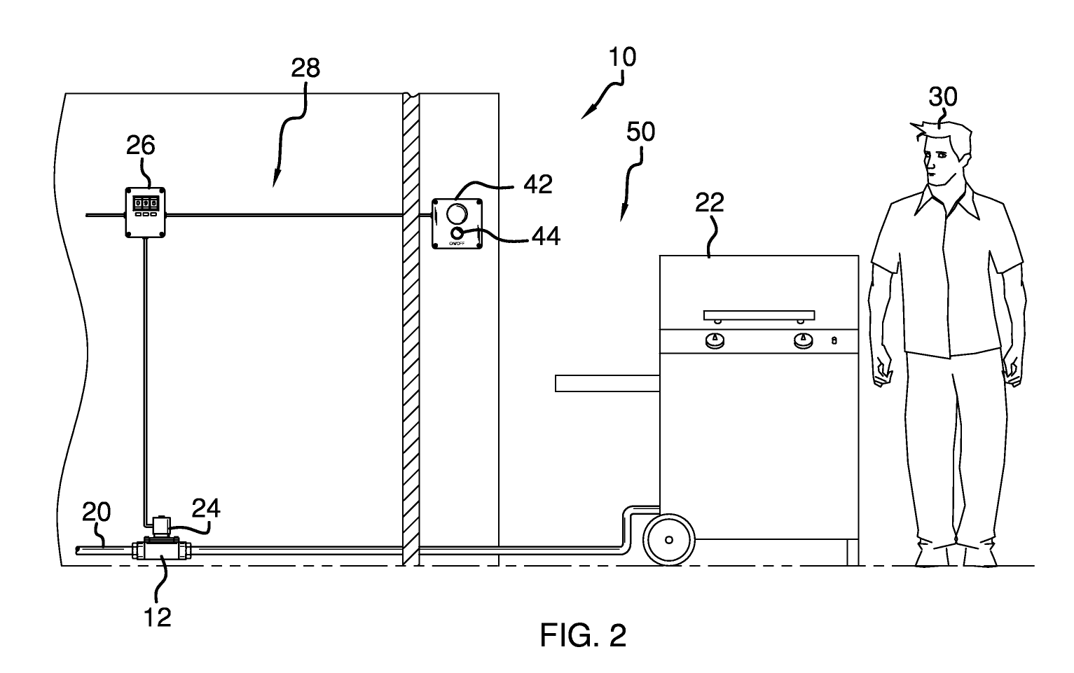

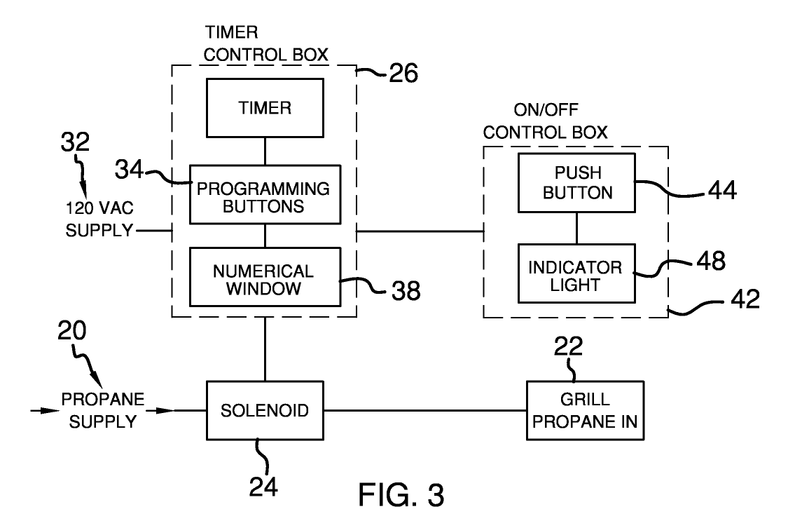

With reference now to the drawings, and in particular to FIGS. 1 through 3 thereof, a new metering device embodying the principles and concepts of an embodiment of the disclosure and generally designated by the reference numeral 10 will be described.

As best illustrated in FIGS. 1 through 3, the fuel metering assembly 10 generally comprises a valve 12. The valve 12 has an outer wall 14 extending between an inlet 16 and an outlet 18 of the valve 12. The inlet 16 is fluidly coupled to a fuel supply 20. The outlet 18 is fluidly coupled to a cooking appliance 22. The fuel supply 20 may be a propane tank or the like. Additionally, the cooking appliance 22 may be a gas grill or the like. The valve 12 may be a gaseous fuel valve or the like.

A solenoid 24 is provided. The solenoid 24 is coupled to the outer wall 14 of the valve 12. Moreover, the solenoid 24 is in mechanical communication with the valve 12 such that the solenoid 24 opens the valve 12 when the solenoid 24 is actuated. Thus, the valve 12 allows a flow of a fuel to the cooking appliance 22. The solenoid 24 closes the valve 12 when the solenoid 24 is de-actuated such that the valve 12 restricts the flow of the fuel to the cooking appliance 22.

A timer 26 is provided. The timer 26 is positioned in a secure location 28 such that timer 26 may be concealed from a user 30 utilizing the cooking appliance 22. The secure location 28 may be an interior of a building or the like. The timer 26 is electrically coupled to a power source 32. The power source 32 may be an electrical power line or the like. The timer 26 is electrically coupled to the solenoid 24 such that the timer 26 selectively actuates and de-actuates the solenoid. 24

A plurality of time actuators 34 is each coupled to a front side 36 of the timer 26. Each of the time actuators 34 is engaged to select a duration of time for the solenoid 24 to be actuated. Thus, the valve 12 is opened for the selected duration of time. Each of the timer actuators 34 selects a respective one of a single minute, tens of minutes and hundreds of minutes. The duration of time may range between 1 minute and 999 minutes.

A display 38 is coupled to the front side 36 of the timer 26. The display 38 displays a plurality of numerals 40 that indicates the selected duration of time. Each of the numerals 40 in the display 38 is selected with an associated one of the time actuators 34. Additionally, each of the numerals 40 in the display may range between 0 and 9. The display 38 may be an analog display or the like.

A control 42 is provided. The control 42 is positioned proximate the cooking appliance 22 such that the control 42 may be accessible to the user 30. The control 42 is electrically coupled to the timer 26.

A primary actuator 44 is coupled to a forward side 46 of the control 42. The primary actuator 44 is engaged by the user 30 such that the timer 26 actuates the solenoid for the selected duration of time. A light emitter 48 is coupled to the forward side 46 of the control 42. The light emitter 48 emits light when timer 26 actuates the solenoid 24. Thus, the light emitter 48 notifies the user 30 that the valve 12 is open. The light emitter 48 ceases emitting light when the timer 26 de-actuates the solenoid 24.

In use, the assembly 10 is utilized in a public cooking area 50 in order to restrict an amount of the fuel consumed by the cooking appliance 22. The selected duration of time is entered into the timer 26 by an individual who is granted access to the secure location 28. The primary actuator 44 is actuated when the user 30 wishes to utilize the cooking appliance 22. The selected duration of time resets each time the primary actuator 44 is actuated.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fuel metering assembly comprising:
a solenoid fluidly coupled between a fuel supply and a cooking appliance such that said solenoid is configured to control a flow of a fuel to the cooking appliance;
a timer being positioned in a secure location such that timer is configured to be concealed from a user, said timer being electrically coupled to a power source, said timer being electrically coupled to said solenoid such that said timer selectively actuates and de-actuates said solenoid;
a plurality of time actuators coupled to said timer, each of said time actuators being engaged to select a duration of time for said solenoid to be actuated wherein said solenoid allows the flow of the fuel to the cooking appliance for the selected duration of time;
a display coupled to said timer, said display displaying numerals indicating the selected duration of time;
a control positioned proximate the cooking appliance such that said control is configured to be accessible to the user, said control being electrically coupled to said timer;
a primary actuator coupled to said control, said primary actuator being engaged by the user such that said timer actuates said solenoid for the selected duration of time; and
a light emitter coupled to said control, said light emitter emitting light when said primary solenoid is actuated such that said light emitter is configured to notify the user that said solenoid is allowing the flow of the fuel to the cooking appliance, said light emitter ceasing emitting light when said timer de-actuates said solenoid.

2. The assembly according to claim 1, further comprising a valve having an outer wall extending between an inlet and an outlet of said valve, said inlet being fluidly coupled to the fuel supply, said outlet being fluidly coupled to the cooking appliance.

3. The assembly according to claim 2, further comprising said solenoid being coupled to said outer wall of said valve, said solenoid being in mechanical communication with said valve such that said solenoid opens said valve when said solenoid is actuated wherein said valve is configured to allow the flow of the fuel to the cooking appliance.

4. The assembly according to claim 3, further comprising said solenoid closing said valve when said solenoid is de-actuated wherein said valve is configured to restrict the flow of the fuel to the cooking appliance.

5. A fuel metering assembly comprising:
a valve, said valve having an outer wall extending between an inlet and an outlet of said valve, said inlet being fluidly coupled to a fuel supply, said outlet being fluidly coupled to a cooking appliance;
a solenoid, said solenoid being coupled to said outer wall of said valve, said solenoid being in mechanical communication with said valve such that said solenoid opens said valve when said solenoid is actuated wherein said valve is configured to allow a flow of the fuel to the cooking appliance, said solenoid closing said valve when said solenoid is de-actuated wherein said valve is configured to restrict the flow of the fuel to the cooking appliance;
a timer being positioned in a secure location such that timer is configured to be concealed from a user, said timer being electrically coupled to a power source, said timer being electrically coupled to said solenoid such that said timer selectively actuates and de-actuates said solenoid;
a plurality of time actuators coupled to said timer, each of said time actuators being engaged to select a duration of time for said solenoid to be actuated wherein said valve is opened for the selected duration of time;
a display coupled to said timer, said display displaying numerals indicating the selected duration of time;
a control positioned proximate the cooking appliance such that said control is configured to be accessible to a user, said control being electrically coupled to said timer;
a primary actuator coupled to said control, said primary actuator being engaged by the user such that said timer actuates said solenoid for the selected duration of time; and
a light emitter coupled to said control, said light emitter emitting light when said primary solenoid is actuated such that said light emitter is configured to notify the user that said valve is open, said light emitter ceasing emitting light when said timer de-actuates said solenoid.
